(19) United States
(12) Patent Application Publication
(10) Pub. No.: US 2011/0040586 A1
(43) Pub. Date: Feb. 17, 2011

(54) METHODS AND SYSTEMS FOR PROVIDING SOCIAL NETWORKING-BASED ADVERTISEMENTS

(76) Inventors: Alan Murray, Weston, VT (US); Joshua Abram, New York, NY (US); Rodney Hook, New York, NY (US); Balaji Devarajan, Edison, NJ (US)

Correspondence Address: Byrne Poh LLP, 11 Broadway, Ste 865, New York, NY, 10004, US

(21) Appl. No.: 12/118,216

(22) Filed: May 9, 2008

Related U.S. Application Data
(60) Provisional application No. 60/928,288, filed on May 9, 2007.

(51) Int. Cl. G06Q 30/00; G06Q 10/00

(52) U.S. Cl. 705/7

(57) ABSTRACT

Methods and systems for providing social networking-based advertisements are provided. In accordance with some embodiments, methods for providing social networking-based advertisements to users are provided, the method comprising: collecting user information relating to a user from a user profile on a social networking website, wherein the user information includes relationship data that describes a social network of members of the social networking website connected to the user; determining whether the user information has missing attributes; in response to determining that the user information has missing attributes, deriving the missing attributes from users profiles associated with the members of the social network; using the collected user information and the missing attributes to select an advertisement; and providing the selected advertisement to the user and at least one member of the social network associated with the user.

### CROSS REFERENCE TO RELATED APPLICATION

This application claims the benefit of U.S. Provisional Patent Application No. 60/928,288, filed May 9, 2007, which is hereby incorporated by reference herein in its entirety.

### TECHNICAL FIELD

The disclosed subject matter relates to methods and systems for providing social networking-based advertisements. More particularly, the disclosed subject matter relates to determining attribute data from a plurality of relationship data that is present on a social networking website and using relationship data and/or the determined attribute data to more efficiently present media to users.

### BACKGROUND

Social networking websites, such as MySpace, Friendster, and Facebook, have grown in popularity in the past few years. A member of a social networking website establishes an account and creates relationships with other accounts, thereby connecting the members in a network. When a member connects with other members, that member is publicly expressing their mutual friendship or association. In addition, members of these social networking websites provide descriptive personal profiles that include their likes, their dislikes, demographic information, etc. These personal profiles and links to other members create a social network.

Members of these social networking websites spend a considerable amount of time on the websites, where each member is shown a number of advertisements. It has been reported that social networking websites, such as MySpace, display over one billion advertisements per day. However, a majority of these displayed advertisements are often disregarded by members. Even though these social networking websites possess an enormous amount of information on each member and present a number of advertisements per day, advertisers and social networking websites have done little to leverage this wealth of information.

Conventional solutions include, for example, tracking a member's visitations to websites partnered with the social networking website to provide targeted advertisements to the member. Whether or not the member chooses to include or post information relating to these visitations on the member's profile, the social networking website receives the visitation information, associates the visitation information directly with the member, and uses it to target advertisements to the member. In addition, the member is generally not able to opt out of allowing the social networking website to receive such information. Accordingly, there has been a growing need to address these privacy concerns in social networking websites.

Thus, it would be desirable to provide an advertisement application that integrates relationship data together with existing and determined attribute data from members of a social networking website to deliver relevant media content to those members.

### SUMMARY

Methods and systems for providing social networking-based advertisements are provided. In accordance with some embodiments, methods for providing social networking-based advertisements to users are provided, the method comprising: collecting user information relating to a user from a user profile on a social networking website, wherein the user information includes relationship data that describes a social network of members of the social networking website connected to the user; determining whether the user information has missing attributes; in response to determining that the user information has missing attributes, deriving the missing attributes from users profiles associated with the members of the social network; using the collected user information and the missing attributes to select an advertisement; and providing the selected advertisement to the user and at least one member of the social network associated with the user.

### BRIEF DESCRIPTION OF THE DRAWINGS

Various objects, features, and advantages of the present invention can be more fully appreciated with reference to the following detailed description of the invention when considered in connection with the following drawing, in which like reference numerals identify like elements.

FIG. 1 is a simplified flowchart illustrating the creation of an enhanced profile and selection of one or more advertisements in accordance with some embodiments of the present invention.

FIGS. 2-5 are illustrative user profile screens that may be provided in accordance with some embodiments of the present invention.

FIG. 6 is an example of low value advertisements that are generally provided to the user.

FIG. 7 is an illustrative user profile screen that is vetted for inappropriate content in accordance with some embodiments of the present invention.

FIG. 8 is an illustrative user profile screen that is coded based on the information in the user profile in accordance with some embodiments of the present invention.

FIG. 9 is an illustrative user relationship screen that shows the user's established relationships in accordance with some embodiments of the present invention.

FIGS. 10 and 11 are illustrative user profile screens that include social network-based advertisements that may be provided in accordance with some embodiments of the present invention.

FIG. 12 is an illustrative micronetwork screen that may be provided in accordance with some embodiments of the present invention.

FIG. 13 is an illustrative index of relevant words and topics that may be used in accordance with some embodiments of the present invention.

FIG. 14 is an illustrative flowchart showing the use of a recommendation engine to create an enhanced profile in accordance with some embodiments of the present invention.

FIG. 15 is a schematic diagram of an illustrative system on which an interactive advertising application may be implemented in accordance with some embodiments of the present invention.

FIG. 16 is a schematic diagram of an illustrative workstation and server as provided, for example, in FIG. 15 in accordance with some embodiments of the present invention.

FIG. 17 is a schematic diagram of an illustrative system on which the interactive advertising application may be implemented in accordance with some embodiments of the present invention.

### DETAILED DESCRIPTION

In accordance with various embodiments, mechanisms for deriving information from user profiles from social networking providers and using the derived information to provide media content to users are provided. These mechanisms can be used in a variety of applications.

In accordance with various embodiments, an interactive advertising application (sometimes referred to herein as “the application”) is provided. The application derives information from user profiles on a social networking website and uses the derived information to provide advertisements and other media content to users or members of a social network or other web-based service. Information from a user profile may include, for example, user-inputted demographic data, user-selected or user-identified relationship data, etc. Relationship data may include, for example, the other users or members that the user has an established relationship or friendship or any other suitable information that defines the user's social network.

It should be noted that information obtained from the user (e.g., the user profile) and information derived about the user may be used to serve advertisements and/or other suitable media content to members within the user's social network. In some embodiments, the information is not used by the application provide the user with additional advertisements. For example, in response to the user selecting an advertisement on the social networking website relating to hybrid automobiles, the application may determine whether to transmit that advertisement (or similar advertisements) to one or more of the members within the user's social network. In another example, in response to the user visiting a website relating to hybrid automobiles, the application may determine whether to transmit an advertisement relating to hybrid automobiles to one or more members of the social networking website that the user has visited (e.g., accessed the member's page on the social networking website) within the past ten days.

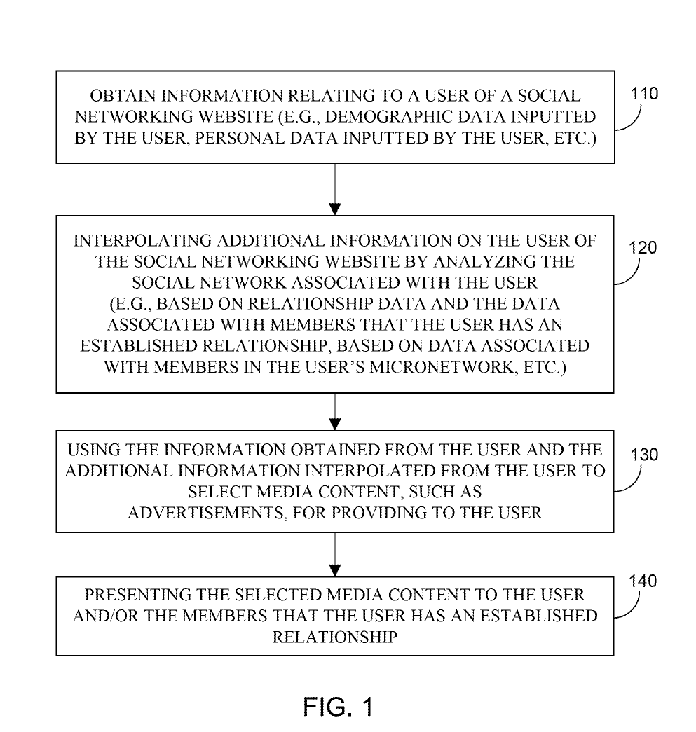

Turning to FIG. 1, a simplified flowchart illustrating the steps performed in providing an application that selects and displays advertisements in accordance with some embodiments of the present invention is provided. This is a generalized flow chart. It will be understood that the steps shown in FIG. 1 may be performed in any suitable order, some steps may be deleted, and others added.

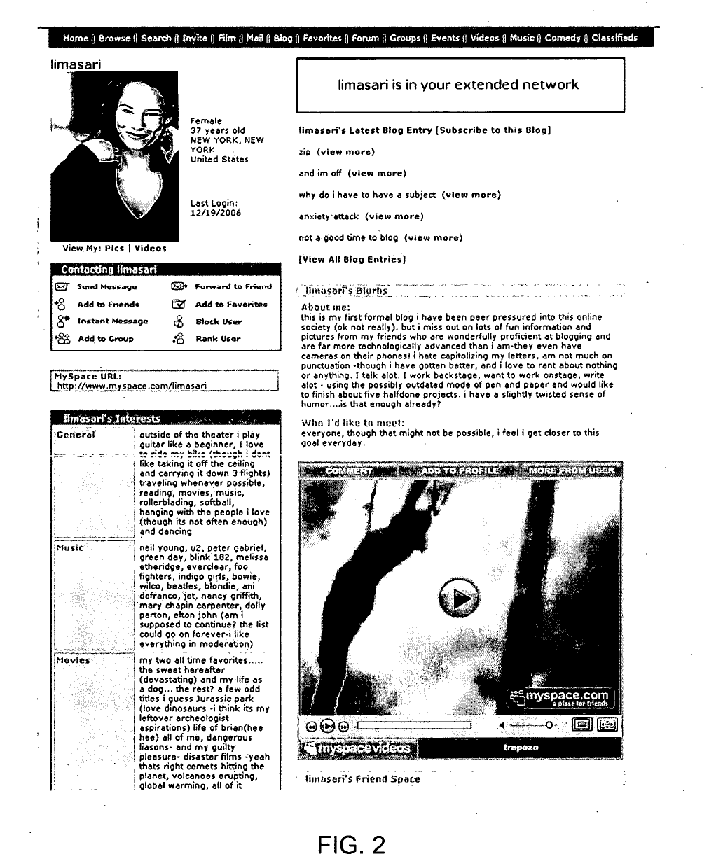

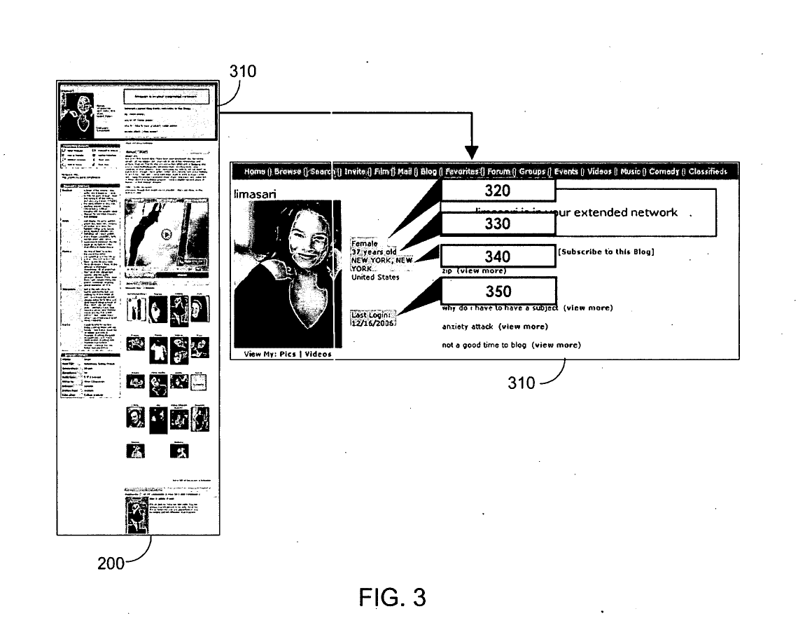

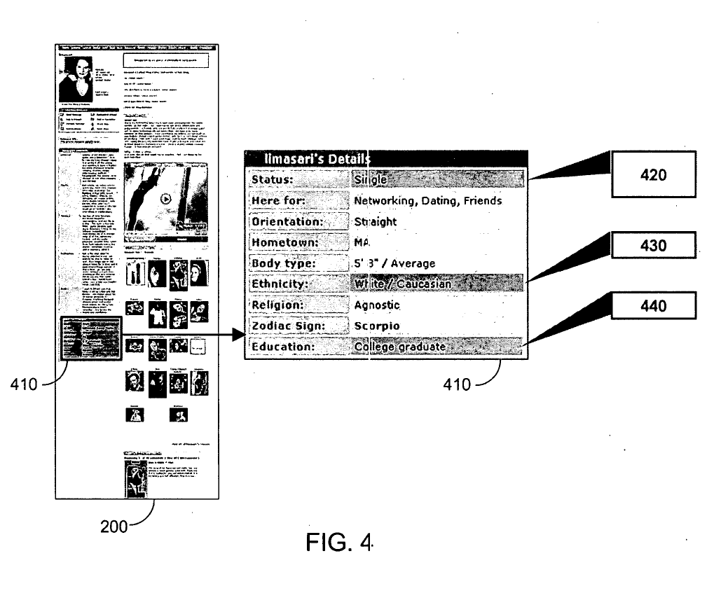

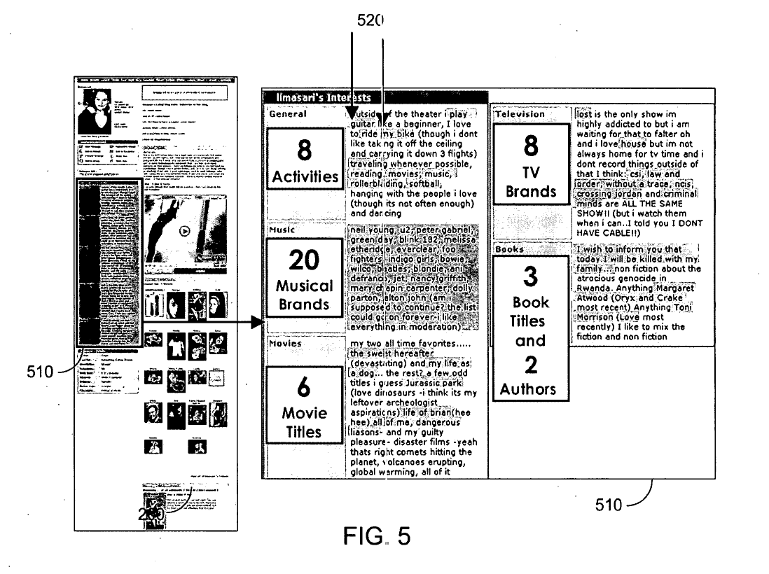

As shown in FIG. 1, the process begins with obtaining information relating to a user of a social networking website from the user profile (step 110). Information from the user profile may include, for example, demographic data inputted by the user (e.g., age, race, gender, geographic location, sexual orientation, religion, marital status, etc.), personal data inputted by the user (e.g., general interests, preferred music artists, preferred movie titles, preferred television shows, preferred book titles and authors, hobbies, etc.), personal data relating to the user that was inputted by other users, and any other suitable information relating to the user. For example, as shown in FIGS. 2 and 3, the application may determine that the user is a 37 year old female from New York, N.Y. from profile 200 of FIG. 2 and fields 320, 330, and 340 of FIG. 3. The application may also determine that the user is an active member because the user has recently logged into the social networking website from field 350. As shown in FIG. 4, the application may also determine from profile 200 that the user is single, white/Caucasian, and a college graduate from fields 420, 430, and 440. As shown in FIG. 5, the application may analyze the personal data inputted by the user 520 and determine activities associated with the user—e.g., enjoys playing the guitar, enjoys riding bicycles, enjoys traveling, enjoys reading, enjoys movies, enjoys music, enjoys rollerblading, and enjoys playing softball. As also shown, the application may determine the musical brands, movie titles, television shows, book titles, and authors to associated with the user. For example, the user enjoys the artists “Blondie” and “Jet,” the movies entitled “The Sweet Hereafter” and “My Life As A Dog,” the television programs “Law and Order” and “House,” the book titles “Oryx” and “Crake,” and the authors “Margaret Atwood” and “Toni Morrison.” The application obtains this information from profile 200 and associates it with the user.

In some embodiments, the application may crawl through user profiles to collect raw HyperText Markup Language (HTML) data or any other suitable from user pages. Beginning with a seed Uniform Resource Locator (URL) of the profile page, the HTML can be downloaded and stored into a raw HTML database. In some embodiments, the application may parse a unique identifier from the URL or the user's page itself. Alternatively, the application may automatically receive raw data from the social networking provider or any other suitable source. For example, the application may submit a request to the social networking provider to transmit raw data from one or more profiles.

In some embodiments, the application may create a queue of personal user profiles to crawl through for collecting raw HTML data. The queue may be created based on, for example, new profiles, profiles that have not been crawled in a predetermined amount of times, etc. For example, the application may submit a request to the social networking provider to transmit raw data from one or more profiles that the application has not crawled in thirty days.

In some embodiments, the application may store and organize raw profile HTML data into a database containing multiple fields of information, such as unique identifiers, user display name, age, gender, favorite music, hobbies, favorite television programs, etc.

It should be noted that, in some embodiments, the web server that is running the social networking website or any other suitable entity that has direct access to the data from user pages may perform the above-mentioned analysis, collection, storage, organization, and/or crawling features.

It should also be noted that the application may prevent information (e.g., identity information, address information, etc.) that can be linked to an individual from being captured. Such information may include, for example, name, e-mail address, etc.

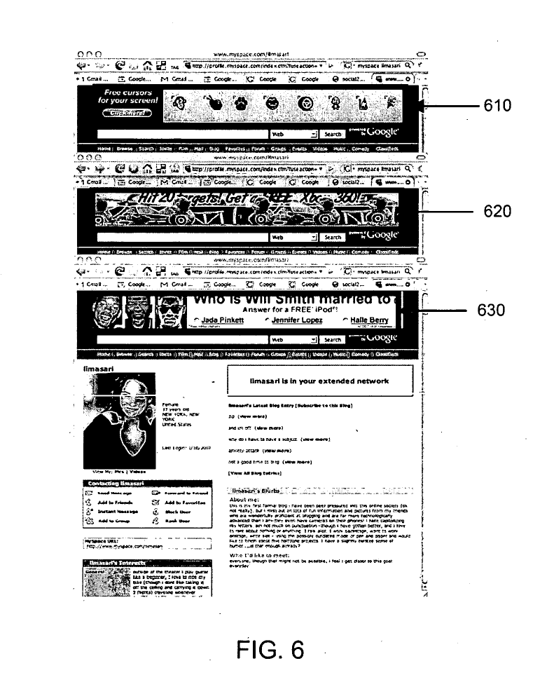

The application uses the information to provide targeted advertisements to the user, one or more members of the user's social network, and/or one or more members of a micronetwork associated with the user. As shown in FIG. 6, the current advertisements 610, 620, and 630 that are provided to the user and the members of the user's social network by social networking providers and/or other advertisers have low value and are not likely to be selected by the user.

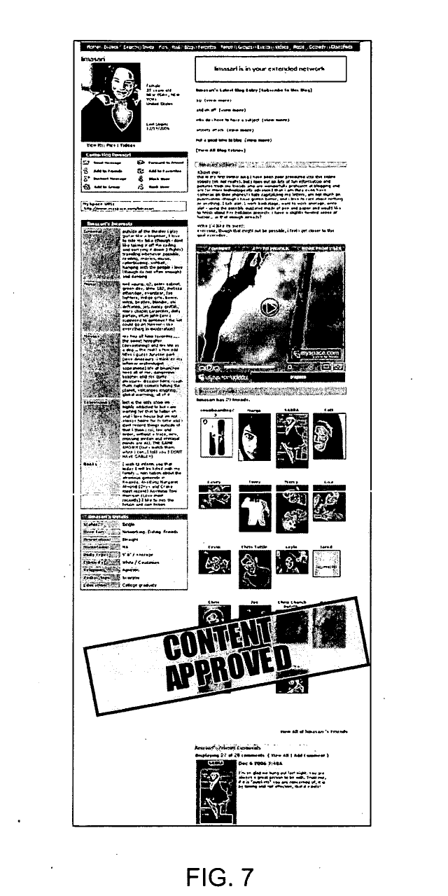

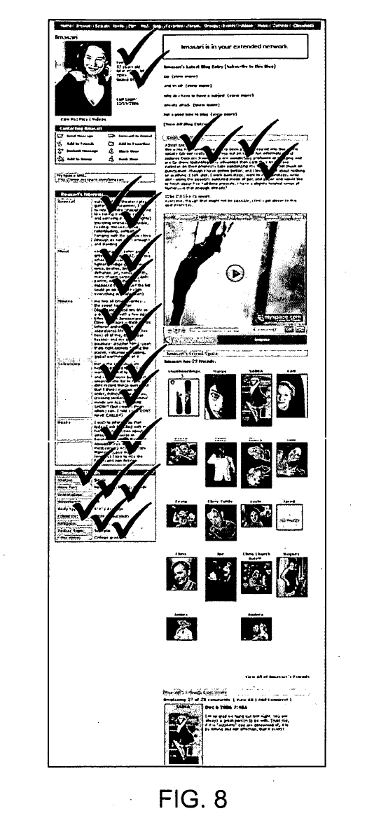

In some embodiments, the application may vet profile 200 or any other content on the social networking website for inappropriate content. For example, in response to analyzing the user profile 200, the application may evaluate the content from the user profile by removing any information that contains pornography and/or hate language (see, e.g., FIG. 7). As shown in FIG. 8, the application may code the user based on the information in the user profile. For example, the application may associate the user with a particular region, gender, marital status, and hobbies. In another example, the application may develop a psychographic profile associated with the user based on the user-inputted associations (e.g., music, movies, books, authors, television programs, etc.).

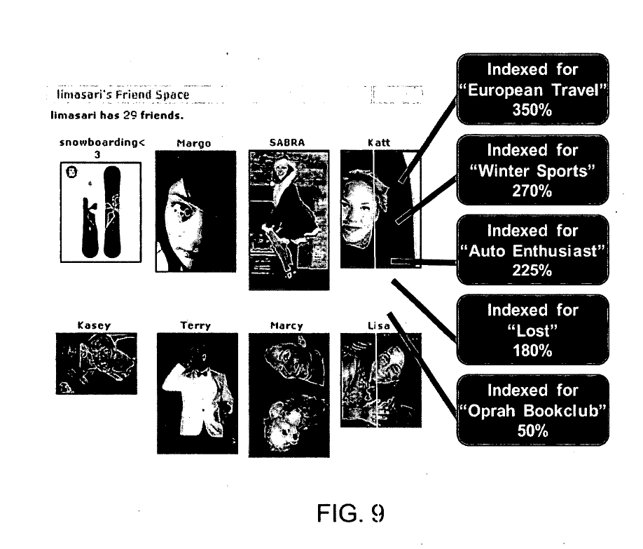

Referring back to FIG. 1, the application may use relationship data, which includes information from other users within the user's social network, to obtain additional information on the user (step 120). In some embodiments, the application may interpolate for information that the application could not obtain from the user profile from the profiles of users in that user's social network (e.g., first degree social network, second degree social network, etc.). For example, the application may determine that the user is a 37 year old female from New York, N.Y. from the profile. In addition, the application may analyze the profiles of the users in the user's social network and determine that the user may also like European Travel, Winter Sports, and the television program “Lost.” As shown in FIG. 9, the application may analyze one or more members within the user's social network (e.g., snowboarding<3, Margo, SABRA, Katt, etc.). After analyzing one or more members within the user's social network, the application may make assumptions on the user's interests. For example, because many of the members within the user's social network are interested in European Travel, the user may also be interested in European Travel. In another example, the application may perform a word density analysis on linked pages or member profiles within the user's social network to identify disparate and shared interests.

It should be noted that a social network is generally an aggregation of members having a relationship with the user. For example, a social network associated with the user may include the friends of the user (e.g., members that have accepted an invitation from the user, members that have transmitted an invitation to the user, etc.), members that are designated as having a direct relationship with the user (one-degree separation), members that are designated as an acquaintance to the user (two-degree separation, three-degree separation, etc.), etc. The social network includes the members having any relation to the user regardless of the number of degrees of separation.

In some embodiments, the application may extract URL links to other member pages listed as friends from the user's page on the social networking website. For example, the application may extract and store URL links to other pages (containing their associated user profiles and user information).

In some embodiments, the application may construct a relationship map that stores a tree of established friend relationship links between personal profiles. Alternatively, the application may construct micronetwork maps showing connections between members on the social networking website (e.g., based on interest, based on activity, based on visitation, etc.). For example, a micronetwork map may include a relationship map overlaid by regions that show the interests shared by the user and the members of the user's social network.

In some embodiments, the application may interpolate missing attributes of a user by statistically determining the common, dominant, and/or average attributes of users within the user's social network. For example, the user of the social networking website did not input the user's age, but the user's age can be reasonably inferred using the average age of the users within the user's social network. It should be noted that interpolating missing attributes of a user may increase the effective research of advertisements. For example, if an advertiser wants to target 25 to 30 year old consumers that enjoy a particular genre of music, and 80% of the user profiles on myspace.com have the age portion of the profile filled in and 60% have the music preferences portion of the profile filled in, the advertiser may increase the effective reach of their advertisements by interpolating these missing attributes.

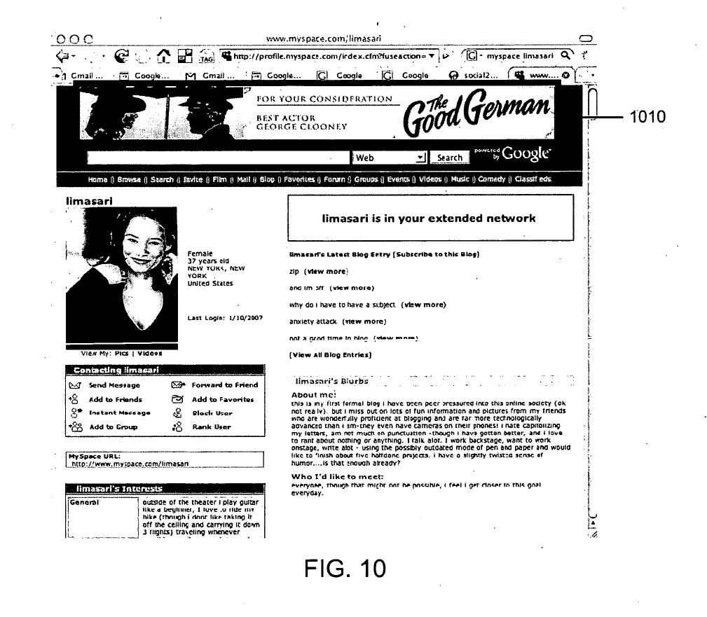

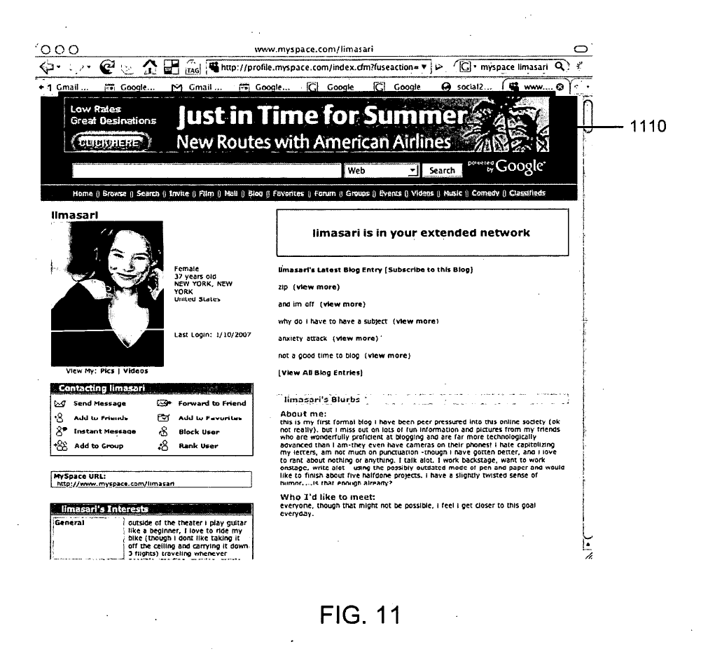

In response to obtaining information from the user profile and analyzing the profiles of other users in the user's social network, the application may select one or more advertisements from a database of advertisements (step 130) and present the advertisements to the user of the social networking website and/or one or more members of the user's social network (step 140). As shown in FIGS. 10 and 11, instead of providing the user with untargeted, low value, low relevancy advertisements (see, e.g., advertisements 610, 620, and 630 of FIG. 6), the application may select one or more advertisements and present the user and/or one or more members of the user's social network with advertisements which are associated with their interests. For example, as shown in FIGS. 10 and 11, in response to obtaining information relating to the user from profile 200 and/or interpolating additional information from the user's social network, the application presents the user and the user's social network with an advertisement 1010 and/or an advertisement 1110. In another example, in response to obtaining information relating to the user from profile 200 and/or interpolating additional information from the user's social network, the application presents one or more members of the user's social network with advertisement 1010 and/or advertisement 1110. In yet another example, in response to obtaining information relating to the user from profile 200 and/or interpolating additional information from the user's social network, the application creates a micronetwork of members (e.g., based on visitation data, based on interest, etc.) and presents members of the micronetwork with advertisement 1010 and/or advertisement 1110.

Alternatively, the application may transmit the obtained and analyzed information to another entity (e.g., a third party social networking enhancement provider, an advertiser, a social networking provider, etc.), where that entity uses the information to present targeted advertisements to the user of the social networking website and the user's social network. For example, the application may transmit the information on the user to an advertiser, where the advertiser selects one or more advertisements from a database connected to the advertiser and provides the selected advertisements directly to the social networking provider for presentation to the user and the user's social network.

It should be noted that the advertisements may include a static advertisement, a rotating advertisement, a video advertisement, an audio advertisement, or any other suitable media content.

In some embodiments, the application may use the relationship information to provide advertisements and/or any other suitable media content to the user of the social networking website and the user's social network. It should be noted that, in some embodiments, the advertisements may be provided to the user and a particular degree of the user's social network. The user's first degree social network includes the other members within the user's social network that have a directly connection with the user. As shown in FIG. 9, the user “limasari” has twenty-nine members within the user's first degree social network. Each of these twenty-nine members (e.g., Margo, SABRA, Katt, Kasey, Terry, etc.) is directly connected to the user. The user's second degree social network includes the other members of the social networking website that are directly connected with the members within the user's first degree social network. For example, the members of the social networking website that are directly connected to the twenty-nine members of the “limasari” social network are part of the user's second degree social network (limasari's friends of friends).

Accordingly, in response to selecting an advertisement for the user, the advertisement may also be presented to members of the user's social network, members within a particular degree of the user's social network (e.g., the user's second degree social network), members of one of the user's micronetworks, and/or members that intersect two or more of the user's micronetwork.

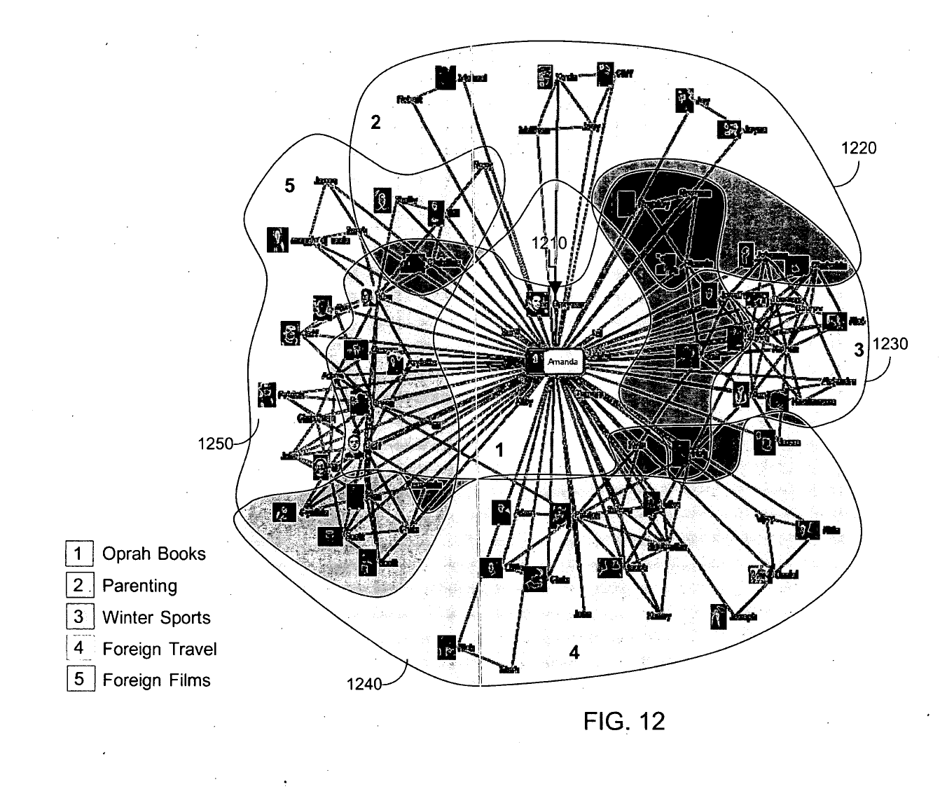

For example, a micronetwork includes members within the user's social network that share a particular interest. As shown in FIG. 12, the user “limasari” may have five interests determined by the application—e.g., Oprah books, parenting, winter sports, foreign travel, and foreign films. The application maps the interests of the user, where the user has multiple topical cohorts or interests shared with the members of the user's social network. The application analyzes the user and the members within the user's social network to determine the different micronetworks within the user's social network. For example, the application may determine that the user “limasari” has an “Oprah Books” micronetwork 1210, a “parenting” micronetwork 1220, a “winter sports” micronetwork 1230, a “foreign travel” micronetwork 1240, and a “foreign films” micronetwork 1250. Using these micronetworks, the application may provide the same or similar advertisements to each user or member within a particular micronetwork. For example, if three members in a particular micronetwork have clicked on Nike advertisements, the application may provide Nike advertisements to each member of the particular micronetwork. It should be noted that the use of micronetwork enables advertisers and/or marketers to provide advertisements and reach out to known enthusiasts (e.g., an enthusiast of Winter Sports) and likely enthusiasts.

It should be noted that information obtained from the user (e.g., the user profile) and information derived about the user may be used to serve advertisements and/or other suitable media content to members within the user's micronetwork. In some embodiments, the information is not used by the application provide the user with additional advertisements. For example, in response to the user selecting an advertisement on the social networking website relating to hybrid automobiles, the application may determine whether to transmit that advertisement (or similar advertisements) to one or more of the members of a user's micronetwork.

It should also be noted that, while the application associates the user with one or more micronetworks, these associations are not transparent to the user. For example, to promote privacy, the application does not reveal to the user, the members of the user's social network, and/or members of the social networking website the different micronetworks associated with each of them. In another example, to promote privacy, the application generally uses information obtained and/or derived about the user to present advertisements to one or more members of the user's social network, one or more members of a micronetwork associated with the user, etc.

In some embodiment, a micronetwork may also include members within the user's social network that have performed a similar action. For example, the user may have recently purchased a hybrid automobile. The application may learn of this information in response to the user posting an announcement on a page of the social networking website (e.g., “I just bought a Honda Prius!”), in response to the user adding an interest (e.g., “saving gas with my new car”), in response to a message posted by a member of the user's social network (e.g., “congratulations on the new hybrid”), or engaging in any other suitable social networking activity. As a result, the application may create a micronetwork that includes members within the user's social network that similar purchased a hybrid automobile. In another example, the application may create a micronetwork that includes members within the user's social network that may be interested (e.g., members that sent a message to the user in response to the purchasing of a hybrid automobile, members that read the user's announcement about the purchasing of a hybrid automobile, etc.).

In some embodiments, a micronetwork may include members that have recently interacted with the user. For example, the application may create a micronetwork that includes members that have recently posted a message to the user or received a message from the user, members that have recently visited the user's page on the social networking website, etc.

Alternatively, the application may transmit an advertisement to an intersection of multiple micronetworks. For example, the application may send an advertisement relating to a foreign film festival in Paris, France to the user and the members that are both part of the “foreign films” micronetwork 1240 and “foreign travel” micronetwork 1250 (the intersection of two micronetworks associated with the user). As shown, the intersection of the “foreign films” micronetwork 1240 and the “foreign travel” micronetwork 1250 includes six members of the social networking website.

It should be noted that micronetworks may be created using any suitable approach. For example, in some embodiments, a micronetwork associated with the user may be created based on the members of the social networking website that the user has visited within the last hour. In another example, in some embodiments, a micronetwork associated with the user may be created based on the advertisement that the user selected (a micronetwork of members that selected the same or similar advertisements). In yet another example, in some embodiments, a micronetwork associated with the user may be created based on the feature that the user accessed on the social networking website (e.g., same trivia feature, same third-party application, etc.).

It should also be noted that one or more micronetworks associated with the user and each micronetwork may continually change. As a user profile changes (e.g., different interests, new interests, etc.), the application may accommodate to the changes by rotating or adjusting the one or more micronetworks associated with the user.

In some embodiments, the application may use feedback information from the user of the social networking website to determine the advertisements to deliver to the user's social network. For example, the application may provide the user with ten advertisements while the user accesses different webpages on the social networking website. The application monitors the user's interactions with the advertisements (e.g., plays with a gaming application associated with the advertisement, clicks on the advertisement, scrolls over the advertisement, watches the media content associated with the advertisement, etc.). Based on monitoring the user's interactions with the advertisements, the application may provide one or more of the same advertisements to one or more members of the user's social network and or micronetwork. For example, the application determines that the user clicks on an advertisement directed to fly fishing. In response to the user selecting that advertisement, the same advertisement directed to fly fishing may be provided to the user's first degree social network. Alternatively, multiple advertisements directed to fly fishing may be provided to the user's “fly fishing” micronetwork and another micronetwork associated with the user (e.g., the user's “retirement” micronetwork).

In some embodiments, the application may use feedback information from the social networking provider to determine which members to monitor. For example, the application may determine that there are twenty members within the user's social network that are highly active (e.g., log onto the social networking website frequently, frequently click on advertisements, etc.). In response, the application may request that the interactions of such highly active members are monitored.

It should be noted that the ten targeted advertisements may be provided to the user of the social networking website in response to the information gleaned from the user's profile and the profiles of the user's social network and/or micronetwork.

Alternatively, the application may monitor advertisements on one or more websites, receive information from one or more third party advertisement networks or advertisement servers, and/or receive information from one or more web servers. For example, when the user visits the webpage of a merchant (e.g., Orvis), the webpage may include pixel tags from third party advertisement networks (e.g., advertisement servers that are affiliated with the webpage). These pixel tags or other embedded objects record that the user's computer has visited the merchant's webpage and provide other information to the advertisement server (e.g., the particular page accessed by the user, the amount of time spent on a particular page, information on the user's computer, information from the user's web browser, etc.). Using the information from the advertisement server, the application may provide or instruct the advertisement server to provide the user and the members within the user's social network with advertisements on other webpages to bring the user and the members back to the merchant's website. Alternatively, the application may use the information from the advertisement server to provide the user and the members within the user's social network with advertisements relating to the subject matter of the merchant's website.

In some embodiments, the application may monitor the behavior of the user and the members within the user's social network or micronetwork to gauge the effectiveness of the selected advertisements. For example, the application may continue to provide the user and the user's social network and/or micronetwork with the selected advertisements until a particular lift over average is no longer achieved. The application may monitor the interactions of the user and the member within the user's social network with the selected advertisements. Based on monitoring the interactions, the application may determine the number of members interacting with each of the advertisements. In some embodiments, each advertisements may have specific requirements attached to the advertisement (e.g., advertisement A is shown until less than 25% of members click on the advertisement, advertisement B is shown until less than 10% of members scroll over the advertisement, etc.). Advertisements that are not selected are less likely to be selected for display to the user and the members within the user's social network or micronetwork, while advertisements that have a high click through rate are more likely to be selected for display.

Alternatively, the application may continue to provide the user and/or members of the user's micronetwork or social network with the selected advertisements until a predetermined time has elapsed.

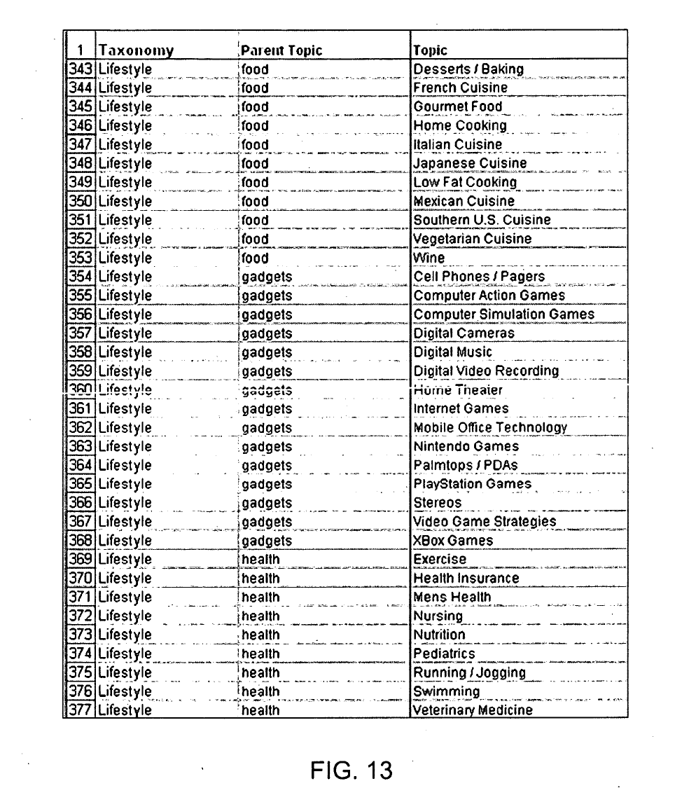

In some embodiments, the application may build one or more indexes associated with the user of the social networking website. One example of an index is shown in FIG. 13, where the index includes a listing of commercially relevant words and topics.

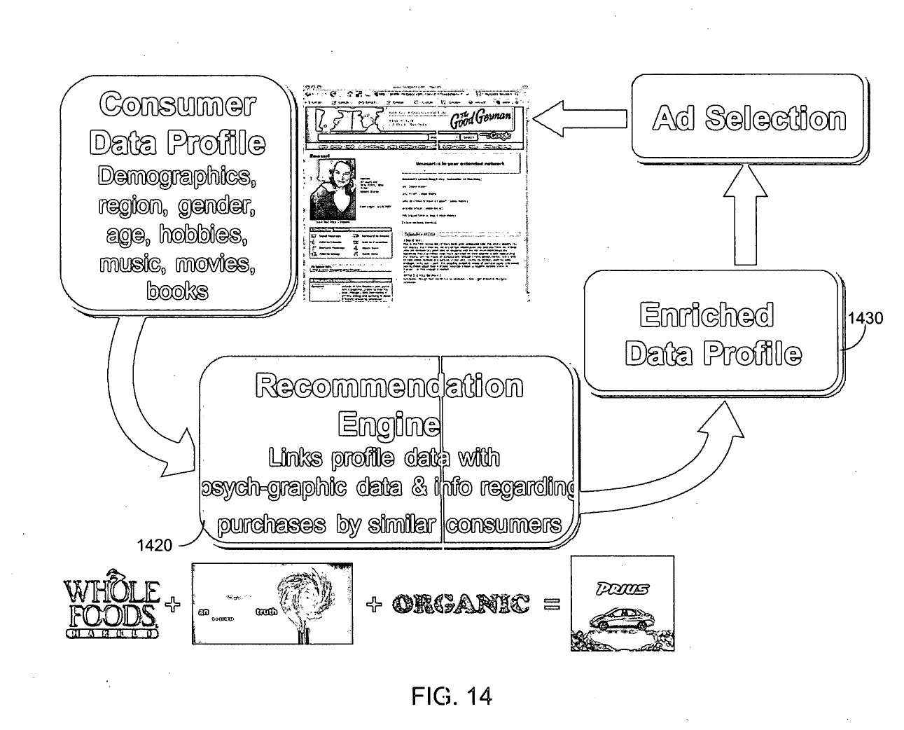

In some embodiments, as shown in FIG. 14, the application may feed the information obtained from the user profile (e.g., profile 200 of FIG. 2) into a recommendation engine. The recommendation engine 1420 may associate the user profile data with psychographic data and other data. For example, when the data associated with the user is the supermarket “Whole Foods,” the movie “An Inconvenient Truth,” and the keyword “organic,” the application may use the recommendation engine to associate additional information with the user. In this example, the recommendation engine associates a hybrid automobile (e.g., the Honda Prius) with the user. This information is added to create an enriched data profile 1430 that is associated with the user. The enriched data profile may be used to select one or more advertisements and present the user, one or more members of the user's social network, and/or one or more members of the user's micronetwork with those advertisements.

In some embodiments, the recommendation engine of the application may perform a semantic analysis that searches through a user profile and the user's descriptive entries for keywords and/or phrases. For example, the application may search for phrases such as “rainbow trout” or “snake river.”

In some embodiments, the application may apply scoring profiles against the ontology of possible consumer interests. For example, the application may determine that the keywords “rainbow trout” and “snake river” indicate a high score for the ontological path of “Hobbies→Sports→Fishing→Fly Fishing.”

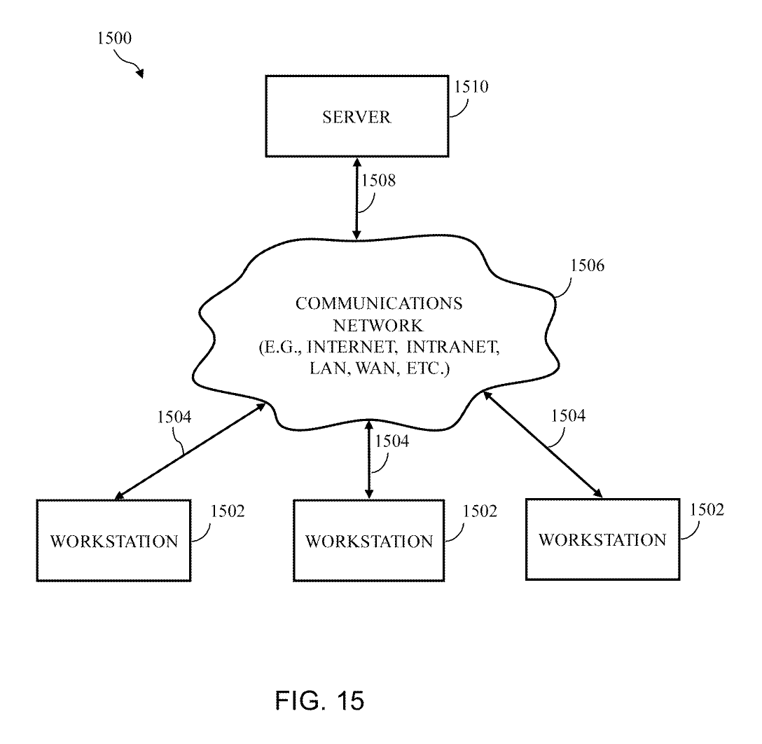

FIG. 15 is a generalized schematic diagram of a system 1500 on which an interactive advertisement application may be implemented in accordance with some embodiments of the present invention. As illustrated, system 1500 may include one or more workstations 1502. Workstations 1502 may be local to each other or remote from each other. Workstations 1502 are connected by one or more communications links 1504 to a communications network 1506 that is linked via a communications link 1508 to a server 1510.

System 1500 may include one or more servers 1510. Server 1510 may be any suitable server for providing access to the application, such as a processor, a computer, a data processing device, or a combination of such devices. Communications network 106 may be any suitable computer network including the Internet, an intranet, a wide-area network (“WAN”), a local-area network (“LAN”), a wireless network, a digital subscriber line (“DSL”) network, a frame relay network, an asynchronous transfer mode (“ATM”) network, a virtual private network (“VPN”), or any combination of any of such networks. Communications links 1504 and 1508 may be any communications links suitable for communicating data between workstations 1502 and server 1510, such as network links, dial-up links, wireless links, hard-wired links, any other suitable communications links, or a combination of such links. Workstations 1502 enable a user to access features of the application. Workstations 1502 may be personal computers, laptop computers, mainframe computers, dumb terminals, data displays, Internet browsers, personal digital assistants (“PDAs”), two-way pagers, wireless terminals, portable telephones, any other suitable access device, or any combination of such devices. Workstations 1502 and server 1510 may be located at any suitable location. In one embodiment, workstations 1502 and server 1510 may be located within an organization. Alternatively, workstations 1502 and server 1510 may be distributed between multiple organizations.

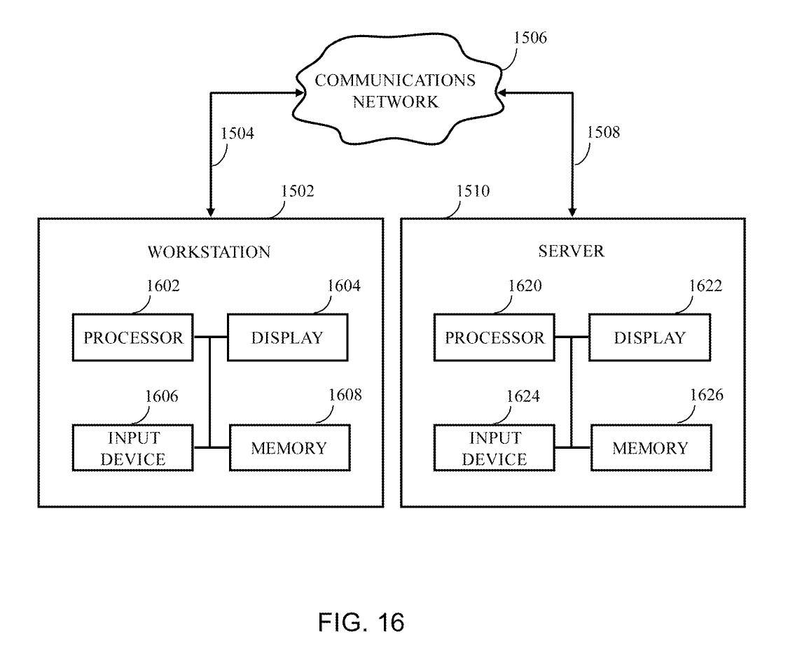

The server and one of the workstations, which are depicted in FIG. 15, are illustrated in more detail in FIG. 16. Referring to FIG. 16, workstation 1502 may include processor 1602, display 1604, input device 1606, and memory 1608, which may be interconnected. In a preferred embodiment, memory 1608 contains a storage device for storing a workstation program for controlling processor 1602.

Processor 1602 uses the workstation program to present on display 1604 the application and the data received through communications link 1504 and commands and values transmitted by a user of workstation 1502. It should also be noted that data received through communications link 1504 or any other communications links may be received from any suitable source, such as a social networking website (e.g., www.myspace.com) or any other suitable source. Input device 1606 may be a computer keyboard, a cursor-controller, dial, switchbank, lever, or any other suitable input device as would be used by a designer of input systems or process control systems.

Server 1510 may include processor 1620, display 1622, input device 1624, and memory 1626, which may be interconnected. In a preferred embodiment, memory 1626 contains a storage device for storing data received through communications link 1508 or through other links, and also receives commands and values transmitted by one or more users. The storage device further contains a server program for controlling processor 1620.

In some embodiments, the application may include an application program interface (not shown), or alternatively, the application may be resident in the memory of workstation 1502 or server 1510. In another suitable embodiment, the only distribution to workstation 1502 may be a graphical user interface (“GUI”) which allows a user to interact with the application resident at, for example, server 110.

In one particular embodiment, the application may include client-side software, hardware, or both. For example, the application may encompass one or more Web-pages or Web-page portions (e.g., via any suitable encoding, such as HyperText Markup Language (“HTML”), Dynamic HyperText Markup Language (“DHTML”), Extensible Markup Language (“XML”), JavaServer Pages (“JSP”), Active Server Pages (“ASP”), Cold Fusion, or any other suitable approaches).

In one particular embodiment, the application may be integrated with a social networking website. For example, the application may display advertisements on the social networking website when the user browses through various pages of the website (e.g., the myspace.com website). In response to the user viewing various pages on the website, the application may select another advertisement to be displayed on a portion of each page of the website.

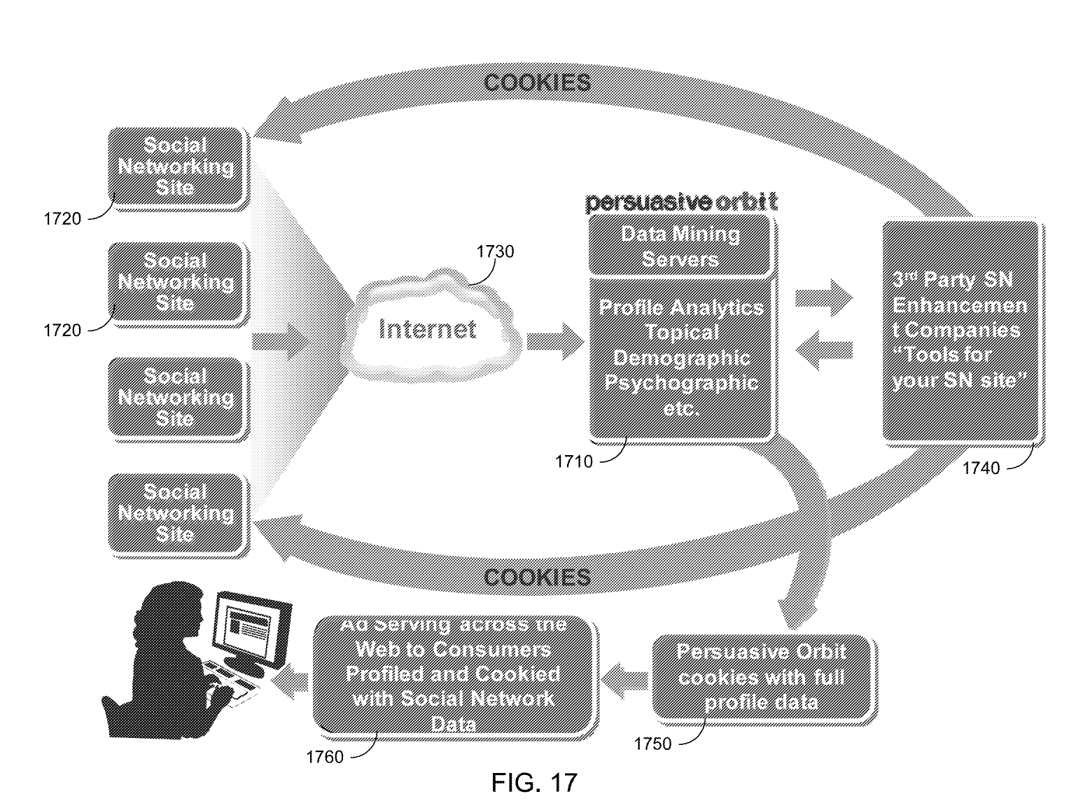

In another embodiment, the application may work in conjunction with a social networking website. For example, as shown in FIG. 17, the application may reside on a server 1710 that receives user profile information from one or more social networking websites 1720 over a communications network 1730 (e.g., the Internet). In response to analyzing the user profile information, analyzing the user's social network, interpolating additional information on the user based on the user's social network, and/or feeding the user profile information through a recommendation engine, the application may transmit the information in an enhanced user profile to, for example, to a third party social networking enhancement entity 1740 that transmits advertisements and provides features to social networking websites. Alternatively, the application may transmit the information in an enhanced user profile 1750 to advertisers 1760 (e.g., in the form of cookies) to allow advertisers to provide targeted advertisements over the Internet.

It should be noted that the application may use cookies to match the user profiles to the author's computer. As advertisements are served on the pages of a social networking website, it may be initially unclear whether the person viewing a profile is the author of a page or a visitor. By using profile page visit frequency and session identifiers, the application stores this information in cookies. Within these cookies, the application sets the best current estimate of the user's unique identifier.

It should also be noted that the application may use cookies to broaden the available inventory of advertisements. For example, when a cookie that includes a unique identifier has been set, the application may target advertisements (as described above) to the user while the user visits the user's profile page and when the user views other pages on the social networking website (e.g., other members' profile pages, other content, etc.).

In some embodiments, at the time of an advertisement request, a packet of data is transmitted to the advertisement server (e.g., a server connected to the social networking website, a server controlled by the advertiser, a server controlled by the application, etc.). The packet may include, for example, cookie information containing the unique identifier. The unique identifier may be looked up in the database and a targeted advertisement may be selected and provided to the user of the social networking website.

Although the application is described herein as being implemented on a workstation and/or server, this is only illustrative. The application may be implemented on any suitable platform (e.g., a personal computer (“PC”), a mainframe computer, a dumb terminal, a data display, a two-way pager, a wireless terminal, a portable telephone, a portable computer, a palmtop computer, an H/PC, an automobile PC, a laptop computer, a cellular phone, a personal digital assistant (“PDA”), a combined cellular phone and PDA, etc.) to provide such features.

It will also be understood that the detailed description herein may be presented in terms of program procedures executed on a computer or network of computers. These procedural descriptions and representations are the means used by those skilled in the art to most effectively convey the substance of their work to others skilled in the art.

A procedure is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations described herein which form part of the present invention; the operations are machine operations. Useful machines for performing the operation of the present invention include general purpose digital computers or similar devices.

The present invention also relates to apparatus for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove more convenient to construct more specialized apparatus to perform the required method steps. The required structure for a variety of these machines will appear from the description given.

The system according to the invention may include a general purpose computer, or a specially programmed special purpose computer. The user may interact with the system via e.g., a personal computer or over PDA, e.g., the Internet, an Intranet, etc. Either of these may be implemented as a distributed computer system rather than a single computer. Similarly, the communications link may be a dedicated link, a modem over a POTS line, the Internet and/or any other method of communicating between computers and/or users. Moreover, the processing could be controlled by a software program on one or more computer systems or processors, or could even be partially or wholly implemented in hardware.

Although a single computer may be used, the system according to one or more embodiments of the invention is optionally suitably equipped with a multitude or combination of processors or storage devices. For example, the computer may be replaced by, or combined with, any suitable processing system operative in accordance with the concepts of embodiments of the present invention, including sophisticated calculators, hand held, laptop/notebook, mini, mainframe and super computers, as well as processing system network combinations of the same. Further, portions of the system may be provided in any appropriate electronic format, including, for example, provided over a communication line as electronic signals, provided on CD and/or DVD, provided on optical disk memory, etc.

Any presently available or future developed computer software language and/or hardware components can be employed in such embodiments of the present invention. For example, at least some of the functionality mentioned above could be implemented using Visual Basic, C, C++ or any assembly language appropriate in view of the processor being used. It could also be written in an object oriented and/or interpretive environment such as Java and transported to multiple destinations to various users.

Accordingly, an interactive advertisement application is provided.

It is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Although the invention has been described and illustrated in the foregoing illustrative embodiments, it is understood that the present disclosure has been made only by way of example, and that numerous changes in the details of implementation of the invention may be made without departing from the spirit and scope of the invention, which is only limited by the claims which follow. Features of the disclosed embodiments can be combined and rearranged in various ways.

What is claimed is:

1. A method for providing social networking-based advertisements to users, the method comprising:
collecting user information relating to a user from a user profile on a social networking website, wherein the user information includes relationship data that describes a social network of members of the social networking website connected to the user;
determining whether the user information has missing attributes;
in response to determining that the user information has missing attributes, deriving the missing attributes from users profiles associated with the members of the social network;
using the collected user information and the missing attributes to select an advertisement; and
providing the selected advertisement to the user and at least one member of the social network associated with the user.

2. The method of claim 1, further comprising statistically deriving the missing attributes by calculating an average or a common denominator from user information associated with the user profiles of members within the social network.

3. The method of claim 1, wherein the collected user information and the missing attributes include at least one interest associated with the user, the method further comprising creating a micronetwork of members in the social network that share the at least one interest.

4. The method of claim 3, further comprising:
using the collected user information and the missing attributes to select the advertisement for the user, wherein the advertisement relates to the at least one interest; and
providing the selected advertisement that relates to the at least one interest to the user and the micronetwork.

5. The method of claim 3, further comprising statistically deriving the missing attributes by calculating an average or a common denominator from user information associated with the user profiles of members within the micronetwork.

6. The method of claim 1, wherein the collected user information and the missing attributes include a plurality of interests associated with the users the method further comprising:
creating a plurality of micronetworks, wherein each micronetwork includes members in the social network that share at least one interest from the plurality of interests; and
using the collected user information and the missing attributes to select the advertisement for the user, wherein the advertisement relates to the at least one interest from the plurality of interests; and
providing the selected advertisement that relates to the at least one interest to the user and members of the social networking website that are included in at least two micronetworks.

7. The method of claim 1, further comprising creating a queue that includes a plurality of the user profiles, wherein each of the plurality of the user profiles has not had user information collected from the user profile in a predetermined amount of time.

8. The method of claim 1, further comprising inhibiting private user information associated with the user profile from being collected.

9. The method of claim 1, wherein the collected user information includes links to various members of the social networking website, the method further comprising creating a micronetwork of the various members of the social networking website.

10. The method of claim 1, further comprising:
creating an enriched user profile that includes the collected user information and the missing attributes; and
transmitting the enriched user profile to an entity that selects and provides an advertisement for the user and the social network.

11. The method of claim 10, wherein the entity is one of: a third party social networking enhancement provider, an advertiser, and a social networking provider.

12. The method of claim 1, wherein the at least one member of the social network is provided with the selected advertisement based on a degree of separation.

13. The method of claim 12, wherein the degree of separation associated with the selected advertisement is determined based on a statistical model.

14. The method of claim 1, further comprising:
monitoring interactions of the user with the selected advertisement; and
in response to receiving a positive response to the selected advertisement, providing the selected advertisement to one or more members in the social network.

15. The method of claim 1, further comprising:
monitoring interactions of the user with the selected advertisement; and
in response to the user interacting with the selected advertisement, providing the selected advertisement to one or more members in the social network.

16. The method of claim 1, further comprising calculating the effectiveness of the selected advertisement based on particular actions, wherein the selected advertisement is provided to the user and the at least one member of the social network until a particular effectiveness is not achieved.

17. The method of claim 16, wherein the effectiveness is calculated by calculating the lift over average of the selected advertisement.

18. The method of claim 1, further comprising:
receiving effectiveness requirements from an advertiser associated with the selected advertisement; and
providing the selected advertisement to the user and the at least one member of the social network until the received effectiveness requirements are not achieved.

19. The method of claim 1, further comprising creating a micronetwork that includes the user and one or more members of the social networking website and that is associated with the user, wherein:
the collected user information and the missing attributes are associated with the micronetwork and are not associated with the user; and
the micronetwork is created based on at least one of: an interest, a visitation to a member, and a selection of the advertisement.

20. A system for providing social networking-based advertisements to users, the system comprising:
a processor that:
collects user information relating to a user from a user profile on a social networking website, wherein the user information includes relationship data that describes a social network of members of the social networking website connected to the user;
determines whether the user information has missing attributes;
in response to determining that the user information has missing attributes, derives the missing attributes from users profiles associated with the members of the social network;
uses the collected user information and the missing attributes to select an advertisement for the user; and
provides the selected advertisement to the user and at least one member of the social network associated with the user.

21. The system of claim 20, wherein the processor is further configured to statistically derive the missing attributes by calculating an average or a common denominator from user information associated with the user profiles of members within the social network.

22. The system of claim 20, wherein the collected user information and the missing attributes include at least one interest associated with the user, and wherein the processor is further configured to create a micronetwork of members in the social network that share the at least one interest.

23. The system of claim 22, wherein the processor is further configured to:
use the collected user information and the missing attributes to select the advertisement for the user, wherein the advertisement relates to the at least one interest; and
provide the selected advertisement that relates to the at least one interest to the user and the micronetwork.

24. The system of claim 22, wherein the processor is further configured to statistically derive the missing attributes by calculating an average or a common denominator from user information associated with the user profiles of members within the micronetwork.

25. The system of claim 20, wherein the collected user information and the missing attributes include a plurality of interests associated with the user, and wherein the processor is further configured to:
create a plurality of micronetworks, wherein each micronetwork includes members in the social network that share at least one interest from the plurality of interests; and
use the collected user information and the missing attributes to select the advertisement for the user, wherein the advertisement relates to the at least one interest from the plurality of interests; and
provide the selected advertisement that relates to the at least one interest to the user and members of the social networking website that are included in at least two micronetworks.

26. The system of claim 20, wherein the processor is further configured to create a queue that includes a plurality of the user profiles, wherein each of the plurality of the user profiles has not had user information collected from the user profile in a predetermined amount of time.

27. The system of claim 20, wherein the processor is further configured to inhibit private user information associated with the user profile from being collected.

28. The system of claim 20, wherein the collected user information includes links to various members of the social networking website, and wherein the processor is further configured to create a micronetwork of the various members of the social networking website.

29. The system of claim 20, wherein the processor is further configured to:
create an enriched user profile that includes the collected user information and the missing attributes; and
transmit the enriched user profile to an entity that selects and provides an advertisement for the user and the social network.

30. The system of claim 29, wherein the entity is one of: a third party social networking enhancement provider, an advertiser, and a social networking provider.

31. The system of claim 20, wherein the at least one member of the social network is provided with the selected advertisement based on a degree of separation.

32. The system of claim 31, wherein the degree of separation associated with the selected advertisement is based on a statistical model.

33. The system of claim 20, wherein the processor is further configured to:
monitor interactions of the user with the selected advertisement; and
in response to receiving a positive response to the selected advertisement, provide the selected advertisement to one or more members in the social network.

34. The system of claim 20, wherein the processor is further configured to:
monitor interactions of the user with the selected advertisement; and
In response to the user interacting with the selected advertisement, providing the selected advertisement to one or more members in the social network.

35. The system of claim 20, wherein the processor is further configured to calculate the effectiveness of the selected advertisement based on particular actions, and wherein the selected advertisement is provided to the user and the at least one member of the social network until a particular effectiveness is not achieved.

36. The system of claim 35, wherein the processor is further configured to calculate lift over average of the selected advertisement.

37. The system of claim 20, wherein the processor is further configured to:
receive effectiveness requirements from an advertiser associated with the selected advertisement; and
provide the selected advertisement to the user and the at least one member of the social network until the received effectiveness requirements are not achieved.

38. The system of claim 20, wherein the processor is further configured to create a micronetwork that includes the user and one or more members of the social networking website and that is associated with the user, wherein the collected user information and the missing attributes are associated with the micronetwork and are not associated with the user, and wherein the micronetwork is created based on at least one of: an interest, a visitation to a member, and a selection of the advertisement.
